(19) United States
(12) Patent Application Publication
(10) Pub. No.: US 2013/0136377 A1
(43) Pub. Date: May 30, 2013

(54) METHOD AND APPARATUS FOR BEAUTIFYING HANDWRITTEN INPUT

(71) Applicant: Samsung Electronics Co., Ltd., Gyeonggi-do (KR)

(72) Inventors: Zhenbo LUO, Beijing (CN); Youxin CHEN, Beijing (CN); Yan WANG, Beijing (CN)

(73) Assignee: Samsung Electronics Co., Ltd., Gyeonggi-do (KR)

(21) Appl. No.: 13/687,489

(22) Filed: Nov. 28, 2012

(30) Foreign Application Priority Data
Nov. 29, 2011 (CN) 201110388171.2

(51) Int. Cl. G06T 5/00

(52) U.S. Cl. CPC G06T 5/00
USPC 382/275

(57) ABSTRACT

A method for beautifying handwritten input, including collecting handwriting data input by a user; analyzing the handwriting data to get handwriting information, determining a corresponding pen tip model according to the handwriting information, and beautifying the user's handwriting with the pen tip model; and outputting the beautified handwriting. An apparatus for beautifying handwritten input determines a pen tip model that matches a user's handwriting by acquiring handwriting information input by the user, and carries out real-time beautification of the user's handwriting through the pen tip model. Changes of the user's handwriting are quickly captured to provide the user to receive timely feedback and an excellent user experience.

### CLAIM OF PRIORITY

Applicant claims the benefit of priority from Chinese Patent Application 201110388171.2 filed Nov. 29, 2011, the contents of which is hereby incorporated by reference in its entirety.

### BACKGROUND OF THE INVENTION

1. Field of the Invention

The present invention relates to the technical field of data entry that is input to a terminal. More particularly, the present invention relates to a method and an apparatus for beautifying handwritten input.

2. Description of the Related Art

Handwriting refers to particular shape characteristics of letters written by individuals while holding a writing instrument, and the formation of which varies with persons. Variations in handwriting may reflect the characters, and/or a number of physiological and psychological factors of different writers. It may even be affected by physical appearance. Handwriting is often more flexible and original than printing of text created by, for example, a keyboard. People also believe that handwriting can reflect personal characteristics of a person such as personality, emotion, culture literacy, regional differences, etc. Therefore, handwritten characters are usually regarded as an inseparable and irreplaceable form of art in people's life and culture.

With the advent of information age, and the popularization of network communications such as e-mails, printed characters of standard criteria are usually adopted in input, display and the like of terminal devices, as it is more efficient to use representations of characters by machines that can use, for example ASCII code. Owning to the special artistic values of handwriting, over the last ten years or so, a significant quantity of algorithms for beautifying handwriting by computer technologies have been introduced by scientific and technical literatures and patents. For example, beautification effect is obtained by methods such as oval-based marked stroke, stroke contour interpolation and stroke generation, etc. Also, the reduced size of portable devices has resulted in a decreased keyboard size on device that still have keys, both virtual and real, such that hand motion such as stroke generation is becoming more desirable.

In the field of data entry, when comparing handwritten input with input via a keyboard, handwritten input generally has advantages such as being intuitional, user-friendly, convenient and fast, etc. With the development and population of digital instrument and touch-screen technology, the application of handwritten input becomes increasingly prevalent and desirable in various input devices such as mobile terminals, including mobile telephones, PDA's, tablets, panel PCs, writing boards, etc. In recent year, a calligraphy style-like beautification on the basis of a user's input handwriting has been developed with limited success.

Conventional methods for beautifying handwriting are partially based on convergence of recognition result and templates, partially based on models, and partially based on handwriting conversion and stroke rendering. Among the existing conventional handwriting beautification methods for beautifying based on strokes, some perform beautification techniques only after the user completes input of the entire handwriting, while other perform beautification after the user finishes inputting a single stroke or several strokes. Although these methods obtain some beautification effects, due to the certain delay relative to a user's input, in conventional methods the user finds it difficult to obtain timely feedback or take part in an excellent user experience.

Accordingly, there is a need in the art to render an effective technical solution to handwriting beautification, which enables real-time presentation of handwriting input by a user when the user inputs through a terminal, and ensures the user receives timely feedback and a satisfying user experience.

### SUMMARY OF THE INVENTION

An object of the present invention is to overcome at least one of the above technical defects, particularly, and to model a pen tip by collecting handwriting information, and carry out real-time beautification of the handwriting through the pen tip model.

In order to achieve the object of the present invention, exemplary embodiments of the present invention set forth a method for beautifying handwritten input, preferably comprising:

collecting handwriting data; analyzing the handwriting data to get handwriting information; determining a corresponding pen tip model according to the handwriting information, and beautifying the user's handwriting with the determined the pen tip model; and outputting the beautified handwriting.

Exemplary embodiments of the present invention additionally set forth an apparatus for beautifying handwritten input, comprising an input unit, a beautifying unit and a display unit, wherein the input unit is used for collecting handwriting data input by a user. The beautifying unit performs analyzing of the handwriting data to get handwriting information, determining a corresponding pen tip model according to the handwriting information, and using the pen tip model to beatify the user's handwriting.

In addition, a display unit displays an output of the beautified handwriting. Here, the pen tip model includes nib shape information and pixel information. For example, the pen tip can be varied depending on the type of nib (e.g., a fountain pen, a ball pen, a brush, a pencil etc.). The pen tip model is modeled according to specific values of the nib shape (eg, a round pen tip, a rectangular pen tip, a quadrate pen tip etc.).

The pen tip model compensates for variations in the user's handwriting by correcting (beautifying) the writing through deforming the pen tip model based on the user's writing style. The above-identified solutions set forth by the present invention determine a pen tip model that matches a user's handwriting by acquiring handwriting information input by the user, and carry out real-time beautification of the user's handwriting through the pen tip model. The above solutions set forth by the present invention can quickly capture changes of the user's handwriting, flexibly and efficiently recover the user's handwriting, which enable the user to receive a timely feedback and excellent user experience.

Additional exemplary aspects and advantages of the present invention will be partially provided in the following discussion, and the present invention will be better understood by a person of ordinary skill in the art.

### BRIEF DESCRIPTION OF THE DRAWINGS

The objects, features and advantages of the present invention will be better understood by a person of ordinary skill in the art from the following detailed description in conjunction with the accompanying drawings, in which:

FIG. 1 is a flow chart providing an overview of a process for beautification of handwritten input according to an exemplary embodiment of the present invention;

FIG. 2 is an exemplary diagram of a pen tip model modeled by a closed contour composed of several spline curves;

FIG. 3 is another exemplary diagram of the pen tip model which is modeled by a bitmap within a close range enclosed by several spline curves;

FIG. 4 is an exemplary schematic diagram of effects of real-time beautification carried out by using the pen tip model of FIG. 2;

FIG. 5 is a schematic diagram of effects of real-time beautification carried out by using the pen tip model of FIG. 3;

FIG. 6 is another flow chart showing exemplary operation of handwritten input beautification according to an exemplary embodiment of the present invention; and

FIG. 7 is an exemplary schematic diagram of the structure of the apparatus for beautifying handwritten input according to an exemplary embodiment of the present invention.

### DETAILED DESCRIPTION

Exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring appreciation of the subject matter of the present invention by a person of ordinary skill in the art. The following embodiments depicted by referral to the description of the drawings are exemplary and are only used for illustrative purposes, not for limiting the present invention.

In a very general overview, the present invention sets forth a method for beautifying handwritten input that preferably includes collecting handwriting data input by a user; analyzing the handwriting data to get handwriting information, determining a corresponding pen tip model according to the handwriting information, and using the pen tip model to beatify the user's handwriting; and outputting the beautified handwriting.

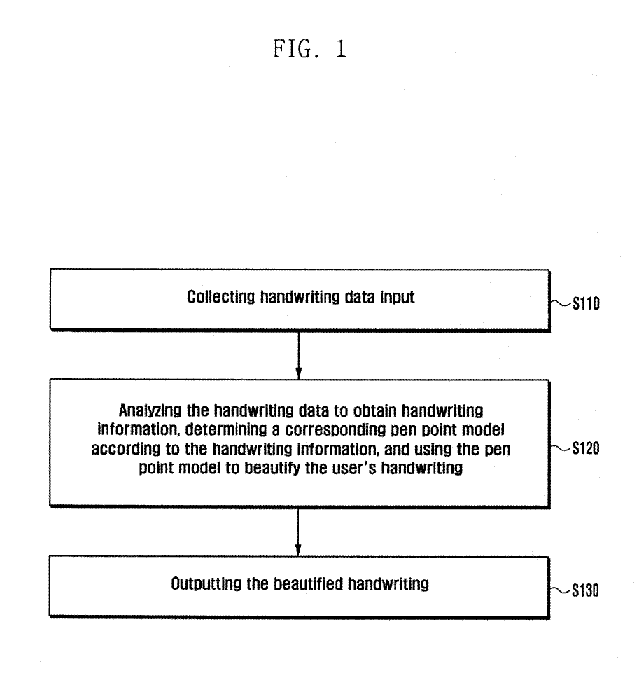

FIG. 1 is a flow chart showing exemplary operation of a method for handwritten input beautification according to the present invention, comprising the following:

At step S110, there is a collecting of handwriting data input to obtain handwriting information. In order to realize the technical solution of the present invention, in step S110, the input of handwriting data of a user should be collected first.

According to an exemplary embodiment of the present invention, the input of handwriting data of a user includes but is not limited to data that can be collected and capable of describing the handwriting, such as x and y coordinate data of the user's handwriting, and/or data information of pressure of the user's handwriting.

The handwriting information includes but is not limited to information that can be collected and capable of describing the handwriting, such as a speed of the handwriting movement, acceleration of the handwriting movement, direction of the handwriting movement, interpolation of the handwriting, pressure distribution of the handwriting and width of the handwriting.

Thereafter, the above handwriting data are stored for future use.

With continued reference to FIG. 1, at S120, the analyzing of the handwriting data to get handwriting information, determining a corresponding pen tip model according to the handwriting information, and using the pen tip model to beatify the user's handwriting all occur.

In more detail, analyzing the handwriting data includes but is not limited to one or more of the following modes:

(i) calculating the speed of the user's handwriting movement; (ii) calculating the acceleration of the user's handwriting movement; (iii) calculating the direction of the user's handwriting movement; (iv) calculating the interpolation of the user's handwriting; (v) calculating the pressure distribution of the user's handwriting; or (vi) calculating the width of the user's handwriting.

More specifically, the calculating speed of the user's handwriting movement is obtained by dividing distances between sampling points by sampling time intervals. More specifically, the calculating acceleration of the user's handwriting movement is obtained by dividing differences between speeds of the user's handwriting at sampling points by sampling time intervals of the sampling points.

In addition, the calculating direction of the user's handwriting movement is obtained by calculating the difference in x-coordinates and difference in y-coordinates at sampling points, and representing the direction of the user's handwriting movement by the differences.

Additionally, the calculating interpolation of the user's handwriting preferably includes the following rules: no interpolation is allowed when a physical distance between two consecutive sampling points is smaller than “T”, wherein, T is a predetermined threshold value in which T>0.

The linear interpolation, spline curve interpolation or polynomial interpolation are carried out with two consecutive sampling points as endpoints, when a physical distance between the two consecutive sampling points is greater than T; wherein, T is a predetermined threshold value, T>0.

More specifically, calculating pressure distribution of the user's handwriting includes:

when a physical distance between two consecutive sampling points is smaller than a set threshold value “T2”, the pressure between the two sampling points is uniformly distributed; and

when a physical distance between two consecutive sampling points is greater than T2, the pressure distribution between the two sampling points is calculated by linear interpolation, spline curve interpolation or polynomial interpolation based on pressure value information of the two consecutive sampling points; wherein T2 is a predetermined threshold value, T2>0.

In addition, calculating width of the user's handwriting comprises the following steps:

an initial value is assigned to a reference width of the user's handwriting according to the input width when the user inputs at least one point;

when the speed of the handwriting increases, the width of the user's handwriting is equal to the reference width minus step value D1, wherein D1>0;

when the speed of the handwriting decreases, the width of the user's handwriting is equal to the reference width plus step value D2, wherein D2>0; and

when the speed of the handwriting remains unchanged, the width of the user's handwriting is equal to the reference width.

In addition, calculating the width of the user's handwriting comprises the following steps:

an initial value is assigned to a reference width of the user's handwriting according to the input width when the user inputs at least one point;

when the acceleration of the handwriting is greater than a set threshold value “A1”, the width of the user's handwriting is equal to the reference width minus step value W1, wherein A1≧0, W1>0;

when the acceleration of the handwriting is smaller than a set threshold value “A2”, the width of the user's handwriting is equal to the reference width plus step value W2, wherein A2 ≦0, W2>0; and

when the acceleration of the handwriting is between the set threshold value A1 and A2, the width of the user's handwriting is equal to the reference width.

Moreover, maximum and minimum values of the reference width may also be set, and the width of the handwriting may be revised by the maximum and minimum values.

Thereafter, the reference width value is preferably updated to the revised width of the handwriting as determined by the aforementioned sub-steps.

For example, an initial value is assigned to a reference width of the user's handwriting when the user inputs at least one point in the current stroke;
If the speed of the handwriting increases, the width of the user's handwriting is equal to the reference width minus step value “D1”, wherein D1>0;
If the speed of the handwriting decreases, the width of the user's handwriting is equal to the reference width plus step value D2, wherein D2>0;
If the speed of the handwriting remains unchanged, the width of the user's handwriting is equal to the reference width; the width range is calculated, the maximum value is “Kmax” X the reference width, wherein Kmax>1, and the minimum value is “Kmin” times of the reference width, wherein 0<Kmin<1; the width of the user's handwriting is compared with the width range, and is revised by methods, for instance, if the width of the user's handwriting is greater than the maximum value in the width range, then the width of the user's handwriting is modified as the maximum value in the width range, if the width of the user's handwriting is smaller than the minimum value in the width range, then the width of the user's handwriting is modified as the minimum value in the width range; the reference width is equal to the revised width of the stroke.

For example, an initial value is assigned to a reference width of the user's handwriting when the user inputs at least one point in the current stroke, and
If the acceleration of the user's handwriting is greater than a set threshold value A1, wherein A1≧0, the width of the user's handwriting is equal to the reference width minus step value W1, wherein W1>0;
If the acceleration of the user's handwriting is smaller than a set threshold value A2, wherein A2≦0, the width of the user's handwriting is equal to the reference width plus step value W2, wherein W2>0;
If the acceleration of the user's handwriting is between the set threshold value A1 and A2, the width of the user's handwriting is equal to the reference width; the width range is calculated, the maximum value is “Lmax” times of the reference width, wherein Lmax>1, and the minimum value is Lmin times of the reference width, wherein 0<Lmin<1; the width of the user's handwriting is compared with the width range, and is revised by methods, for instance, if the width of the user's handwriting is greater than the maximum value in the width range, then the width of the user's handwriting is modified as the maximum value in the width range, if the width of the user's handwriting is smaller than the minimum value in the width range, then the width of the user's handwriting is modified as the minimum value in the width range; the reference width is equal to the revised width of the stroke.

Besides the modes discussed hereinabove, calculating width of the user's handwriting can also comprise:

calculating a width value in linear or non-linear proportional relationship with the handwriting pressure as the width of the user's handwriting according to pressure distribution information of the user's handwriting.

In addition, the width of the user's handwriting may also be set as a constant value.

Finally, step S120 also comprises determining a corresponding pen tip model according to the handwriting information, and using the matched pen tip model to beatify the user's handwriting.

More specifically, the pen tip model preferably comprises:

a closed contour composed of at least one spline curve or line segment, or a bitmap within a closed range enclosed by at least one spline curve or line segment.

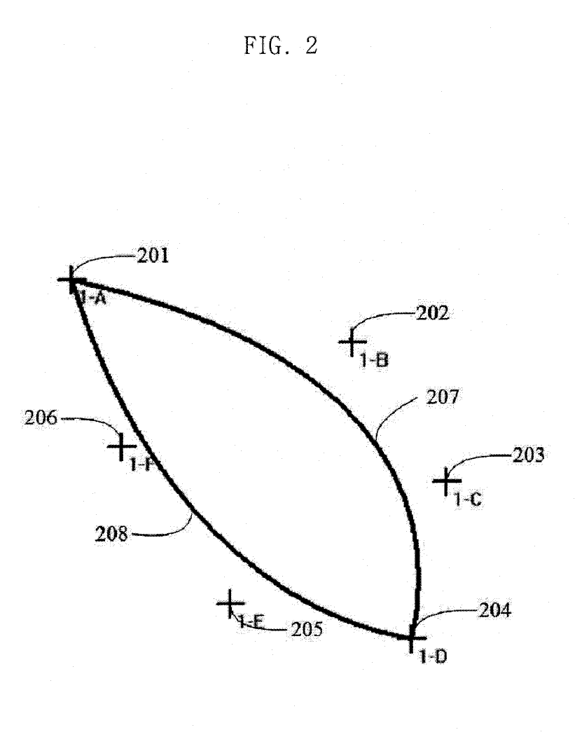

FIG. 2 shows an exemplary diagram of the pen tip model which is modeled by a closed contour composed of several spline curves. In FIG. 2, 201-206 are six control points (1-A to 1-E); 207 and 208 are two spline curves jointed in end-to-end manner, wherein 201, 202, 203, 204 are four control points of the spline curve 207; 204, 205, 206, 201 are four control points of the spline curve 208. The two spline curves 207, 208 form a closed contour, which is a pen tip model similar to the shape of writing brush pen tip.

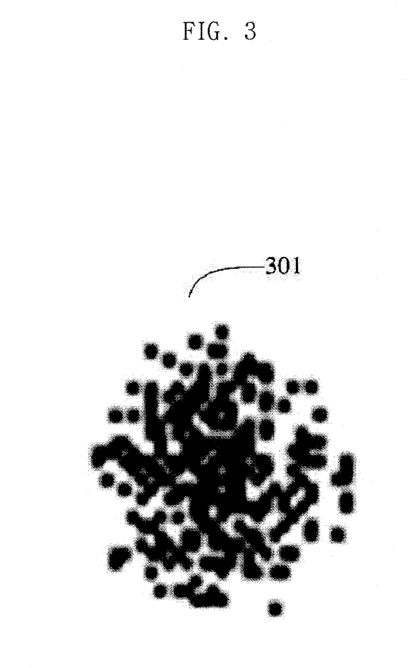

FIG. 3 shows an exemplary diagram of the pen tip model which is modeled by a bitmap within a closed range enclosed by several spline curves. In FIG. 3, 301 is a random bitmap within a closed circular range. 301 is a pen tip model similar to the shape of crayon.

In practice, the pen tip model can be selected from a pen tip model base, as, such base comprises at least one pen tip model. In the above procedure, for example, information of the pen tip model and pen tip model base is stored for invocation of the model hereinafter.

More specifically, determining a corresponding pen tip model comprises:

selecting a pen tip model from a pen tip model base, and deforming the pen tip model according to the handwriting information.

Furthermore, deforming the pen tip model preferably comprises one or more of the following modes:

amplifying or reducing the pen tip model according to width or pressure distribution of the user's handwriting;

translating the pen tip model according to interpolation of the user's handwriting;

rotating the pen tip model according to the direction of the user's handwriting; and

projecting the pen tip model in a particular direction according to the direction of the user's handwriting.

In addition, the beautifying of the user's handwriting using the pen tip model comprises:

translating the deformed pen tip model to a track corresponding to the handwriting, and covering the handwriting. Apparently, since interpolation is an optimal strategy selected based on requirements of performance, thus the track corresponding to the handwriting includes tracks of the handwriting without interpolation or after interpolation.

With reference back to FIG. 1, step S130 comprises: outputting the beautified handwriting.

More specifically, outputting the beautified handwriting comprises rendering output of the beautified handwriting, for example, by:

filling the closed contour in the beautification result by rendering algorithm, in case the pen tip model is a closed contour composed of at least one spline curve or line segment; or

rendering the bitmap in the beautification result by rendering algorithm, in case the pen tip model is a bitmap within a closed range enclosed by at least one spline curve or line segment.

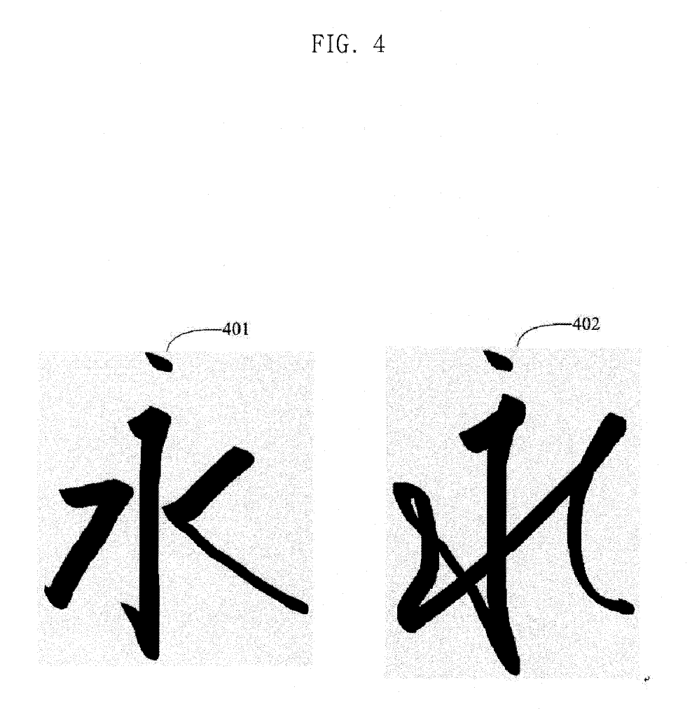

FIG. 4 shows an example of a schematic diagram of effects of real-time beautification carried out by using the pen tip model of FIG. 2. In FIG. 4, 401 shows the effect of real-time beautification of characters written in a style similar to regular script; 402 is the effect of real-time beautification of characters written in a style similar to cursive hand; both 401 and 402 are obtained by covering along the user's handwriting after interpolation by multiple pen tip models, then filling these pen tip contours. It can be seen from the figure that the use of the pen tip model in FIG. 2 permits receiving writing brush like handwritten feedback and beautification effect.

Referring again to FIG. 4, it can be observed from the drawing on the left or right of FIG. 4 that firstly, the pen tip model is amplified or reduced according to width or pressure distribution of the user's handwriting, thereafter, the deformed pen tip model is translated to a track corresponding to the handwriting after interpolation, and the handwriting after interpolation is covered. Deforming the pen tip model includes but is not limited to: translating the pen tip model according to interpolation of the user's handwriting; rotating the pen tip model according to the direction of the user's handwriting; projecting the pen tip model in a particular direction according to the direction of the user's handwriting. For example, the horizontal left-falling curved hook stroke in the middle of the character “ [symbol] ” in the left drawing, and the last short left-falling right-falling stroke of the character “ [symbol] ” in the right drawing achieve the effect of handwriting beautification through pen tip deformation (such as amplifying, reducing or rotating, etc.).

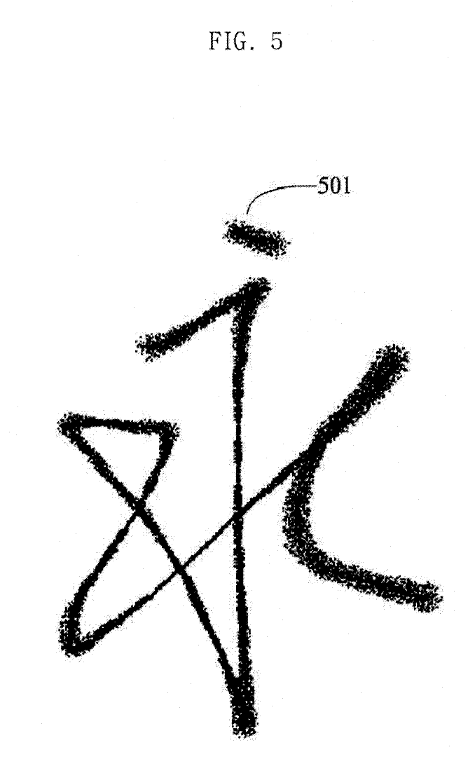

FIG. 5 shows an exemplary schematic diagram of effects of real-time beautification carried out by using the pen tip model of FIG. 3. In FIG. 5, 501 is obtained by covering along the user's handwriting after interpolation using the pen tip model, and then rendering these bitmaps of pen tips. It can be observed from the figure that the use of the pen tip model of FIG. 3 is capable of receiving crayon like handwritten feedback and beautification effect, in addition, the width varies with the speed of the user's handwriting.

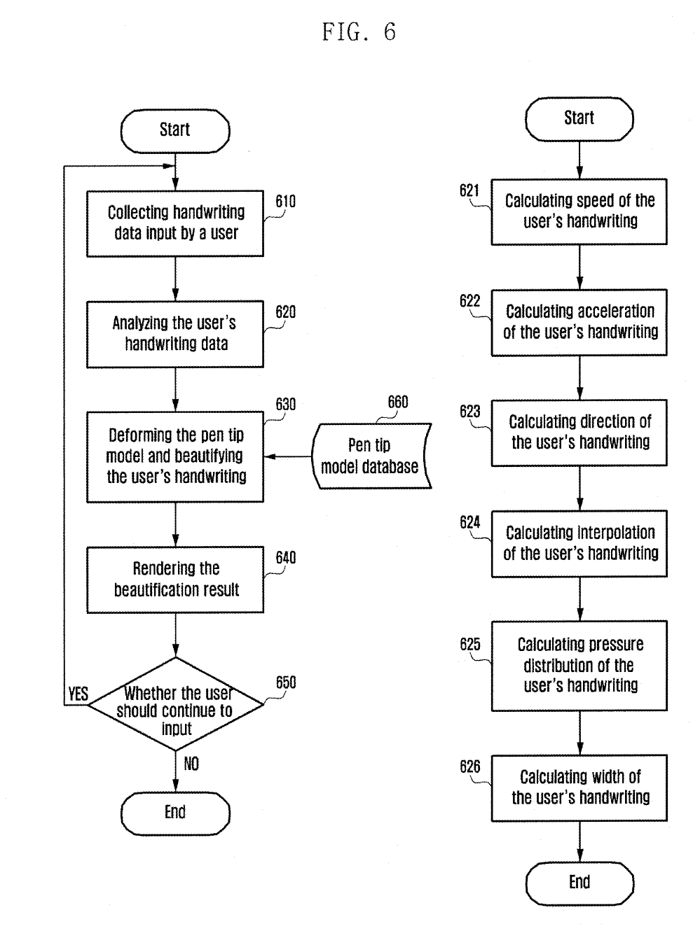

FIG. 6 shows another process flow chart of real-time beautification using pen tip model according to exemplary embodiments of the present invention. The method comprises steps of:

610: collecting handwriting data input by a user;

620: analyzing the user's handwriting data to get handwriting information; 630: deforming the pen tip model according to the handwriting information, and beautifying the user's handwriting using the deformed pen tip model to obtain a beautification result; and

640: rendering the beautification result.

In the above method, step 650 determines whether the user continues to input handwriting, and if yes, the step 610 includes collecting handwriting data input by a user is performed.

Referring again to FIG. 6, at step 610 of collecting handwriting data input by a user, the user's handwriting data include: x and y coordinates of the user's handwriting, and/or information of pressure of the user's handwriting, etc. The handwriting information obtained in step 620 of analyzing the user's handwriting data may include: speed of the user's handwriting; acceleration of the user's handwriting; direction of the user's handwriting; interpolation of the user's handwriting; pressure distribution of the user's handwriting; width of the user's handwriting, etc. In step 630 of deforming the pen tip model according to the handwriting information, and beautifying the user's handwriting using the deformed pen tip model, the pen tip model may include: a closed contour composed of at least one spline curve or line segment; or a bitmap within a closed range enclosed by at least one spline curve or line segment. The pen tip model is selected from the pen tip model base which is composed of at least one pen tip model. Methods of deformation of a pen tip model may include: selecting a pen tip model from a pen tip model base; deforming the pen tip model according to the user's handwriting information, wherein, methods for deforming the pen tip model include: amplifying or reducing the pen tip model according to width or pressure distribution of the user's handwriting; translating the pen tip model according to interpolation of the user's handwriting; rotating the pen tip model according to the direction of the user's handwriting; projecting the pen tip model in a particular direction according to the direction of the user's handwriting; a combination of any of the above deformations. Methods for deforming the pen tip model also include other well-known pen tip deformation methods, such as no deformation to the pen tip model. The beautification result obtained includes: several closed contours composed of at least one spline curve or line segment; or several bitmaps within the closed range enclosed by at least one spline curve or line segment.

Wherein, step 620 of analyzing the user's handwriting data includes one or more of: calculating speed of the user's handwriting 621; calculating acceleration of the user's handwriting 622; calculating direction of the user's handwriting 623; calculating interpolation of the user's handwriting 624; calculating pressure distribution of the user's handwriting 625; calculating width of the user's handwriting 626, etc. Step 621 of calculating speed of the user's handwriting proceeds prior to step 622 of calculating acceleration of the user's handwriting, and prior to step 626 of calculating width of the user's handwriting. Steps 621, 622, 623, 624, 625, 626 may also be adjusted as required and present in another reasonable sequence.

The above method set forth by the present invention acquires handwriting information input by a user, determines a pen tip model that matches the user's handwriting, and carries out real-time beautification of the user's handwriting through the pen tip model; moreover, the pen tip model is deformed according to width or pressure distribution of the user's handwriting, thereafter, translates the deformed pen tip model to a track corresponding to the handwriting after interpolation, thus effectively achieves an effect of handwriting beautification. The above method set forth by the present invention is capable of quickly capturing changes of the user's handwriting, flexibly and appropriately recovering the user's handwriting, which enables the user to receive a timely feedback and excellent user experience.

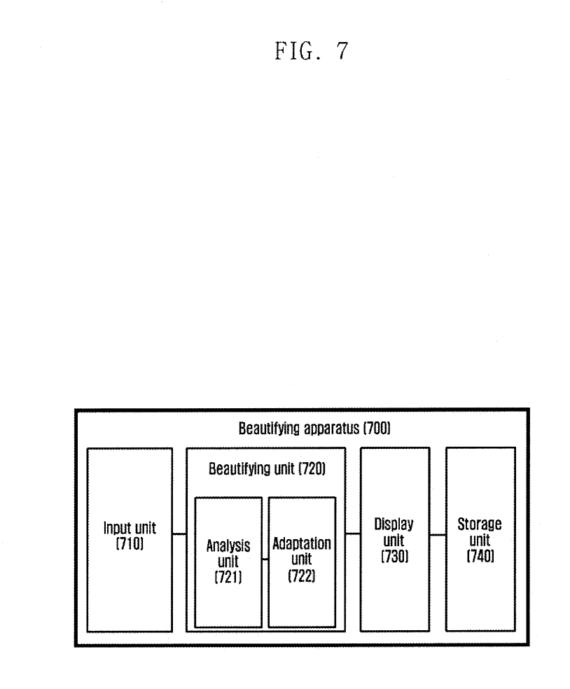

As shown in FIG. 7, there are exemplary embodiments of the present invention on the other hand also related to an apparatus 700 for beautifying handwritten input comprising: input unit 710, beautifying unit 720 and display unit 730.

The input unit 710 is used for collecting handwriting data input by a user.

According to an exemplary embodiment of the apparatus, the handwriting data collected by the input unit 710 may comprise:

x and y coordinate data of the user's handwriting, and/or

data information of pressure of the user's handwriting.

The beautifying unit 720 is used for analyzing the handwriting data to get handwriting information, determining a corresponding pen tip model according to the handwriting information, and using the pen tip model to beatify the user's handwriting. The beautifying unit contains hardware such as a microprocessor or processor that is loaded with machine executable code to perform all of the algorithms shown in the drawings, as well as any of the variations within the spirit and scope of the appended claims.

More specifically, the handwriting information may comprise one or more of the following information:

speed of the handwriting movement, acceleration of the handwriting movement; direction of the handwriting movement; interpolation of the handwriting; pressure distribution of the handwriting or width of the handwriting.

In addition, the pen tip model may include:

a closed contour composed of at least one spline curve or line segment; or

a bitmap within a closed range enclosed by at least one spline curve or line segment.

For example, FIG. 2 exemplarily shows a diagram of the pen tip model which is modeled by a closed contour composed of several spline curves. In FIG. 2, 201-206 are six control points; 207 and 208 are two spline curves jointed in end-to-end manner, wherein 201, 202, 203, 204 are four control points of the spline curve 207; 204, 205, 206, 201 are four control points of the spline curve 208. The two spline curves 207, 208 form a closed contour, which is a pen tip model similar to the shape of writing brush pen tip.

FIG. 3 exemplarily shows a diagram of the pen tip model which is modeled by a bitmap within a closed range enclosed by several spline curves. In FIG. 3, 301 is a random bitmap within a closed circular range. 301 is a pen tip model similar to the shape of crayon.

According to an exemplary embodiment of the invention, in the apparatus, the beautifying unit 720 can automatically selects a pen tip model from a pen tip model base comprising at least one pen tip model.

According to an embodiment of the apparatus, it also comprises a storage unit 740, for example, that is comprised of a non-transitory machine readable medium, and the storage unit 740 stores information such as handwriting data initially input by a user, a pen tip model thereafter, and a pen tip model base, etc.

According to an embodiment of the apparatus, the beautifying unit 720 comprises an analysis unit 721, where analyzing the handwriting data by the analysis unit 721 includes one or more of the following modes:

calculating speed of the user's handwriting movement;

calculating acceleration of the user's handwriting movement;

calculating direction of the user's handwriting movement;

calculating interpolation of the user's handwriting;

calculating pressure distribution of the user's handwriting; or

calculating width of the user's handwriting.

The beautifying unit is a control unit. The analysis unit 721 and the adaptation unit 722 may comprise separate processors or microprocessors configured with machine executable code, or they may be part of the processor or microprocessor of beautifying unit 720. In the event that the units 721 and 722 are software modules comprising machine executable code on respective machine readable mediums or a common machine readable medium, or the machine readable medium such as storage unit 740, they are loaded into a processor or microprocessor and executed to configure the processor or microprocessor as discussed at least as in the examples in the specification and drawings including flowcharts. None of the items shown in FIG. 7 is or can be labeled software per se, as the claimed invention is a statutory apparatus and method in accordance the 35 U.S.C. §101 and the appended claims are interpreted in this regard.

According to an exemplary embodiment of the present invention, calculating speed of the user's handwriting movement by the analysis unit 721 is obtained by dividing distances between sampling points by sampling time intervals.

According to an exemplary embodiment of the present invention, calculating acceleration of the user's handwriting movement by the analysis unit 721 comprises: obtaining by dividing differences between speeds of the user's handwriting at sampling points by sampling time intervals of the sampling points.

According to an exemplary embodiment of the invention, calculating direction of the user's handwriting movement by the analysis unit 721 comprises: calculating difference in x-coordinates and difference in y-coordinates at sampling points, and representing the direction of the user's handwriting movement by the differences.

According to an exemplary embodiment of the invention, calculating interpolation of the user's handwriting by the analysis unit 721 comprises the following steps:

no interpolation is allowed when a physical distance between two consecutive sampling points is smaller than T wherein, T is a predetermined threshold value, T>0;

linear interpolation, spline curve interpolation or polynomial interpolation is carried out with two consecutive sampling points as endpoints, when a physical distance between the two consecutive sampling points is greater than T; wherein, again, T is a predetermined threshold value, T>0.

According to an exemplary embodiment of the invention, calculating pressure distribution of the user's handwriting by the analysis unit 721 comprises:

when a physical distance between two consecutive sampling points is smaller than a set threshold value T2, the pressure between the two sampling points is uniformly distributed;

when a physical distance between two consecutive sampling points is greater than T2, the pressure distribution between the two sampling points is calculated by linear interpolation, spline curve interpolation or polynomial interpolation based on pressure value information of the two consecutive sampling points; wherein T2 is a predetermined threshold value, T2>0.

According to an exemplary an embodiment of the invention, calculating width of the user's handwriting by the analysis unit 721 includes the following:

an initial value is assigned to a reference width of the user's handwriting according to the input width when the user inputs at least one point;

when the speed of the handwriting increases, the width of the user's handwriting is equal to the reference width minus step value D1, wherein D1>0;

when the speed of the handwriting decreases, the width of the user's handwriting is equal to the reference width plus step value D2, wherein D2>0;

when the speed of the handwriting remains unchanged, the width of the user's handwriting is equal to the reference width.

According to an exemplary embodiment of the apparatus, calculating width of the user's handwriting by the analysis unit 721 includes the following:

an initial value is assigned to a reference width of the user's handwriting according to the input width when the user inputs at least one point;

when the acceleration of the handwriting is greater than a set threshold value A1, the width of the user's handwriting is equal to the reference width minus step value W1, wherein A1≧0, W1>0;

when the acceleration of the handwriting is smaller than a set threshold value A2, the width of the user's handwriting is equal to the reference width plus step value W2, wherein A2 ≦0, W2>0;

when the acceleration of the handwriting is between the set threshold value A1 and A2, the width of the user's handwriting is equal to the reference width.

Furthermore, the input unit 710 sets maximum and minimum values of the reference width, and the beautifying unit 720 revises the width of the handwriting by the maximum and minimum values.

Thereafter, it further comprises the beautifying unit 720 updating the reference width to the revised width of handwriting.

Calculating width of the user's handwriting by the analysis unit 721 also includes:

calculating a width value in linear or non-linear proportional relationship with the handwriting pressure as the width of the user's handwriting according to pressure distribution information of the user's handwriting; or

setting the width of the user's handwriting as a constant value.

The beautifying unit 720 further includes an adaptation unit 722, the adaptation unit 722 determining a corresponding pen tip model including:

the adaptation unit 722 selecting a pen tip model from a pen tip model base and deforming the pen tip model according to the handwriting information.

According to an embodiment of the invention, deforming the pen tip model by the adaptation unit 722 comprises one or more of the following modes:

amplifying or reducing the pen tip model according to width or pressure distribution of the user's handwriting;

translating the pen tip model according to interpolation of the user's handwriting;

rotating the pen tip model according to the direction of the user's handwriting;

projecting the pen tip model in a particular direction according to the direction of the user's handwriting.

According to an exemplary embodiment of the invention, the adaptation unit 722 translates the deformed pen tip model to a track corresponding to the handwriting, and covers the handwriting. Since interpolation is an optimal strategy selected based on requirements of performance, thus the track corresponding to the handwriting includes tracks of the handwriting without interpolation or after interpolation.

The display unit 730 is used for outputting the beautified handwriting. The display unit may comprise any type of LCD, LED, OLED, or preferably any other type of thin film technology (TFT) display.

The display unit 730 renders the beautified handwriting to output:
in case the pen tip model is a closed contour composed of at least one spline curve or line segment, the display unit 730 fills the closed contour in the beautification result by rendering algorithm;
in case the pen tip model is a bitmap within a closed range enclosed by at least one spline curve or line segment, the display unit 730 renders a bitmap in the beautification result by rendering algorithm.

For example, FIG. 4 shows an exemplary schematic diagram of effects output by the display unit 730 after using the pen tip model of FIG. 2 to carry out real-time beautification. It can be seen from the figure that the use of the pen tip model in FIG. 2 is capable of receiving writing brush like handwritten feedback and beautification effect.

Accordingly, it can be observed from the drawing on the left or right of FIG. 4 that firstly, the pen tip model is amplified or reduced according to width or pressure distribution of the user's handwriting, thereafter, the deformed pen tip model is translated to a track corresponding to the handwriting after interpolation, and the handwriting after interpolation is covered. Deforming the pen tip model includes but not limited to: translating the pen tip model according to interpolation of the user's handwriting; rotating the pen tip model according to the direction of the user's handwriting; projecting the pen tip model in a particular direction according to the direction of the user's handwriting. For example, in FIG. 4, the horizontal left-falling curved hook stroke in the middle of the character “ [symbol] ” in the left drawing, and the last short left-falling right-falling stroke of the character “ [symbol] ” in the right drawing achieve the effect of handwriting beautification through pen tip deformation (such as amplifying, reducing or rotating, etc).

FIG. 5 shows an exemplary schematic diagram of effects output by the display unit 300 after using the pen tip model of FIG. 3 to carry out real-time beautification. It can be observed from the figure that the use of the pen tip model of FIG. 3 is capable of receiving crayon like handwritten feedback and beautification effect, in addition, it is apparent that the width varies with the speed of the user's handwriting.

It should be understood that the units or templates set forth by the present invention are drawn together in a single apparatus described in FIG. 7 merely for illustrating the invention. Apparently, the units or templates set forth by the present invention may exist in a specific communication system in the form of separated modules, i.e., distributed deployment of the units or molds of the beautifying apparatus, for example, several units are deployed at the server end, several units are deployed at the terminal. Besides the cooperation between the above unit modules, for example, a storage unit for storing data of a user's handwriting and information of pen tip model base may also be included, wherein the pen tip model base is composed of at least one pen tip model. For example, a communication unit for communications between units of the apparatus, as well as for transmitting data such as pen tip model base, data of user's handwriting and real-time beautification result and the like between multiple apparatus as described by the present invention, may also be included. In addition, the apparatus according to the present invention may include communication means to wirelessly communicate with another device, access point, tablet or notepad, or any other type of mobile device, server, etc.

The above apparatus, as set forth by the present invention, acquires handwriting information input by a user, determines a pen tip model that matches the user's handwriting, and carries out real-time beautification of the user's handwriting through the pen tip model; moreover, it deforms the pen tip model according to the information such as width or pressure distribution of the user's handwriting, etc., thereafter, translates the deformed pen tip model to a track corresponding to the handwriting after interpolation, and thus effectively achieves an effect of handwriting beautification. The method set forth by the present invention is capable of quickly capturing changes of the user's handwriting, flexibly and appropriately recovering the user's handwriting, which enables the user to receive a timely feedback and excellent user experience. The apparatus and method can operate automatically and by changeable defaults can be set to perform beautification in a plurality of ways other than what was shown and described in the specification and drawings herein.

The above-described methods according to the present invention can be implemented in hardware, firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein can be loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed invention. Under the broadest reasonable interpretation, the appended claims constitute statutory subject matter in compliance with 35 U.S.C. §101.

The terms “unit” or “module” as used herein is to be understood as constituting hardware such as a processor or microprocessor configured for a certain desired functionality in accordance with statutory subject matter under 35 U.S.C. §101 and does not constitute software per se.

In addition, the respective functional units in the respective exemplary embodiments of the present invention can be aggregated in a processing module, also can singly, physically exist, and also can be aggregated in a module by two or more units. The above aggregated module can be carried out not only by means of hardware but also by means of a software functional module that is executed by a hardware such as a processor or microprocessor. The aggregated module can also be stored in a computer readable memory medium if it is carried out by means of software functional module and is sold or used as an independent product.

The exemplary embodiments of the present invention are provided for the easy description and understanding of the present invention with specific examples but do not limit the scope of the present invention. It will be appreciated by those skilled in the art that various changes and modifications may be practiced without departing from the spirit of the present invention and the scope of the appended claims.

What is claimed is:

1. A method for beautifying handwritten input comprising:
collecting handwriting data input by an input unit;
analyzing by a beautifying unit the collected handwriting data to obtain handwriting information;
determining by the beautifying unit a corresponding pen tip model according to the handwriting information;
beautifying the user handwriting with the pen tip model under control of the beautifying unit by adjusting the pen tip model to compensate for a particular handwriting style; and
outputting the beautified handwriting.

2. The method for beautifying handwritten input according to claim 1, further comprising: the beautifying unit being configured for deforming the pen tip model according to the handwriting information to compensate for the particular handwriting style.

3. The method for beautifying handwritten input according to claim 2, wherein deforming the pen tip model comprises one or more of the following modes:
(i) scaling the pen tip model according to width or pressure distribution of the user's handwriting;
(ii) translating the pen tip model according to interpolation of the user's handwriting;
(iii) rotating the pen tip model according to direction of the user's handwriting; or
(iv) projecting the pen tip model in a particular direction according to the direction of the user's handwriting.

4. The method for beautifying handwritten input according to claim 1, wherein the beautifying unit is configured to adjust the pen tip model to beautify the user's handwriting by:
translating the deformed pen tip model to a trajectory corresponding to the handwriting, and covering the handwriting.

5. The method for beautifying handwritten input according to claim 4, wherein outputting the beautified handwriting comprises rendering the output of the beautified handwriting by:
filling the closed contour in the beautification result by a rendering algorithm, in which the pen tip model is a closed contour composed of at least one spline curve or line segment;
rendering the bitmap in the beautification result by the rendering algorithm, in which the pen tip model is a bitmap within a closed range enclosed by at least one spline curve or line segment.

6. The method for beautifying handwritten input according to claim 1, wherein the handwriting data collected by the input unit comprises one or more of:
x and y coordinate data of the user's handwriting, or
data information of pressure of the user's handwriting.

7. The method for beautifying handwritten input according to claim 1, wherein analyzing the handwriting data comprises one or more of the following modes:
(i) calculating a speed of the user's handwriting movement;
(ii) calculating an acceleration of the user's handwriting movement;
(iii) calculating a direction of the user's handwriting movement;
(iv) calculating an interpolation of the user's handwriting;
(v) calculating a pressure distribution of the user's handwriting; or
(vi) calculating a width of the user's handwriting.

8. The method for beautifying handwritten input according to claim 7, wherein calculating the speed of the user's handwriting movement comprises dividing distances between sampling points by sampling time intervals.

9. The method for beautifying handwritten input according to claim 7, wherein calculating acceleration of the user's handwriting movement comprises dividing differences between speeds of the user's handwriting at sampling points by sampling time intervals of the sampling points.

10. The method for beautifying handwritten input according to claim 7, wherein calculating direction of the user's handwriting movement includes calculating the difference in x-coordinates and the difference in y-coordinates at sampling points, and representing the direction of the user's handwriting movement by the differences.

11. The method for beautifying handwritten input according to claim 7, wherein calculating the interpolation of the user's handwriting comprises the following steps:
when a physical distance between two consecutive sampling points is smaller than T then no interpolation is allowed;
when a physical distance between the two consecutive sampling points is greater than T then performing at least one of linear interpolation, spline curve interpolation or polynomial interpolation with two consecutive sampling points as endpoints,
wherein T is a predetermined threshold value, T>0.

12. The method for beautifying handwritten input according to claim 7, wherein calculating the pressure distribution of the user's handwriting comprises:
when a physical distance between two consecutive sampling points is smaller than a set threshold value T2, the pressure between the two sampling points is uniformly distributed;
when a physical distance between two consecutive sampling points is greater than T2, the pressure distribution between the two sampling points is calculated by at least one of linear interpolation, spline curve interpolation or polynomial interpolation based on pressure value information of the two consecutive sampling points; wherein T2 is a predetermined threshold value, T2>0.

13. The method for beautifying handwritten input according to claim 7, wherein calculating width of the user's handwriting comprises the following steps:
an initial value is assigned to a reference width of the user's handwriting according to the input width when at least one point is input to an input unit;
when the speed of the handwriting increases, the width of the user's handwriting is equal to the reference width minus step value D1, wherein D1>0;
when the speed of the handwriting decreases, the width of the user's handwriting is equal to the reference width plus step value D2, wherein D2>0;
when the speed of the handwriting remains unchanged, the width of the user's handwriting is equal to the reference width.

14. The method for beautifying handwritten input according to claim 7, wherein calculating width of the user's handwriting comprises the following steps:
an initial value is assigned to a reference width of the user's handwriting according to the input width at least one point is input to the input unit;
when the acceleration of the handwriting is greater than a set threshold value A1, the width of the user's handwriting is equal to the reference width minus step value W1, wherein A1≧0, W1>0;
when the acceleration of the handwriting is smaller than a set threshold value A2, the width of the user's handwriting is equal to the reference width plus step value W2, wherein A2 ≦0, W2>0;
when the acceleration of the handwriting is between the set threshold value A1 and A2, the width of the user's handwriting is equal to the reference width.

15. The method for beautifying handwritten input according to claim 13, further comprising:
setting maximum and minimum values of the reference width, and revising the width of the handwriting by the maximum and minimum values; and
updating the reference width to the revised width of handwriting.

16. The method for beautifying handwritten input according to claim 7, wherein calculating width of the user's handwriting comprises:
calculating a width value in linear or non-linear proportional relationship with the handwriting pressure as the width of the user's handwriting according to pressure distribution information of the user's handwriting; or
the width of the user's handwriting being a constant value.

17. The method for beautifying handwritten input according to claim 1, wherein the handwriting information comprises one or more of the following information:
speed of the handwriting movement, acceleration of the handwriting movement; direction of the handwriting movement; interpolation of the handwriting; pressure distribution of the handwriting or width of the handwriting.

18. The method for beautifying handwritten input according to claim 1, wherein the pen tip model comprises:
a closed contour composed of at least one spline curve or line segment; or
a bitmap within a closed range enclosed by at least one spline curve or line segment.

19. An apparatus for beautifying handwritten input, comprising:
an input unit that collects handwriting data input thereon,
a beautifying unit configured for analyzing the collected handwriting data from the input unit to obtain handwriting information, to determine a corresponding pen tip model according to the handwriting information, and control the pen tip model to beautify the user's handwriting, and
a display unit that outputs a display of the beautified handwriting.

20. The apparatus for beautifying handwritten input according to claim 19, wherein the beautifying unit includes an adaptation unit configured for deforming the pen tip model according to the handwriting information.
